(19) United States
(12) Patent Application Publication
(10) Pub. No.: US 2025/0307782 A1
(43) Pub. Date: Oct. 2, 2025

(54) Systems and Methods for Collaboration Before a Scheduled Meeting

(71) Applicant: RingCentral, Inc., Belmont, CA (US)

(72) Inventor: Christopher van Rensburg, Portland, OR (US)

(73) Assignee: RingCentral, Inc., Belmont, CA (US)

(21) Appl. No.: 18/622,666

(22) Filed: Mar. 29, 2024

(51) Int. Cl. G06Q 10/1093; G06Q 10/101

(52) U.S. Cl. CPC G06Q 10/1095; G06Q 10/101

(57) ABSTRACT

The present disclosure provides methods, systems, and mediums for collaboration within a conferencing platform before scheduled meetings. In one aspect of the present disclosure, a computer-implemented method for collaboration within a conferencing platform before scheduled meetings is proposed. The method comprises the steps of receiving a request for a participant to join a scheduled meeting and detecting one or more criteria for the participant of the scheduled meeting. The method further comprises, based on the one or more criteria, moving the participant to a waiting room. The method further comprises moving the participant from the waiting room to the scheduled meeting.

### TECHNICAL FIELD

The present disclosure relates generally to the field of computer-supported meetings/conferences. More specifically, and without limitation, this disclosure relates to systems and methods for collaboration before scheduled meetings or conferences.

### BACKGROUND

Computer-supported communications have gotten more popular over the past several years. For example, the COVID-19 pandemic has had a significant impact on the popularity of computer-supported communications. As a result of this pandemic, many businesses were pushed to perform as much work as possible remotely. This challenge presented the problem of how employees could effectively communicate with each other despite working remotely. Consequently, the use of audio and video meeting services for employee communications increased dramatically. Since an employee can easily connect to meetings digitally using only a laptop or smartphone, communications between employees could be carried out at any time regardless of their location.

In an in-person conference or meeting with a relatively large audience, speakers can physically interact in a pre-meeting briefing, where the host or organizer of the conference may describe roles, the order of speakers, or changes in the predetermined scripts. During these in-person briefings, the interactions of the stakeholders may be beneficial from a psychological perspective. These interactions, despite not being necessary for the objectives of the conference, still help the speakers acclimate and feel more comfortable in discussion between each other. Unfortunately, for online meetings or conferences where the majority of the invitees, attendees, or participants join digitally, not enough attention is given to the pre-meeting collaboration of the speakers.

### SUMMARY

The appended claims may serve as a summary of the invention.

### BRIEF DESCRIPTION OF THE DRAWINGS

The accompanying drawings, which comprise a part of this specification, illustrate several embodiments and, together with the description, serve to explain the principles disclosed herein. In the drawings:

FIG. 1 is a diagram of a communication system, according to an example embodiment of the present disclosure.

FIG. 2 is a diagram of a server, according to an example embodiment of the present disclosure.

FIG. 3 is a diagram of a user device, according to an example embodiment of the present disclosure.

FIGS. 4A-4B are examples of a Graphical User Interface (GUI), according to an example embodiment of the present disclosure.

FIG. 5 is an example GUI, according to another example embodiment of the present disclosure.

FIG. 6 is an example GUI, according to yet another example embodiment of the present disclosure.

FIG. 7 depicts a flowchart for implementing a waiting room within a conferencing platform before a scheduled meeting, according to one example embodiment of the present disclosure.

FIG. 8 depicts another flowchart for implementing a waiting room in which a participant may elect to be moved to a specific waiting room, according to another example embodiment of the present disclosure.

FIG. 9 depicts a flowchart for determining whether a participant should be moved to a waiting room prior to the participant joining the scheduled meeting, according to yet another example embodiment of the present disclosure.

### DETAILED DESCRIPTION

Before various example embodiments are described in greater detail, it should be understood that the embodiments are not limiting, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein.

It should also be understood that the terminology used herein is for the purpose of describing concepts, and the terminology is not intended to be limiting. Unless defined otherwise, all technical and scientific terms used herein have the same meaning as commonly understood by those skilled in the art to which the embodiment pertains.

Unless indicated otherwise, ordinal numbers (e.g., first, second, third, etc.) are used to distinguish or identify different elements or steps in a group of elements or steps, and do not supply a serial or numerical limitation on the elements or steps of the embodiments thereof. For example, “first,” “second,” and “third” elements or steps need not necessarily appear in that order, and the embodiments thereof need not necessarily be limited to three elements or steps. It should also be understood that the singular forms of “a,” “an,” and “the” include plural references unless the context clearly dictates otherwise.

Some portions of the detailed descriptions that follow are presented in terms of procedures, methods, flows, logic blocks, processing, and other symbolic representations of operations performed on a computing device or a server. These descriptions are the means used by those skilled in the arts to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, although not necessarily, these quantities take the form of electrical, optical, or magnetic signals capable of being stored, transferred, combined, compared, and otherwise manipulated in a computer system or computing device or a processor. These signals are sometimes referred to as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “storing,” “determining,” “sending,” “receiving,” “generating,” “creating,” “fetching,” “transmitting,” “facilitating,” “providing,” “forming,” “detecting,” “processing,” “updating,” “instantiating,” “identifying”, “contacting”, “gathering”, “accessing”, “utilizing”, “resolving”, “applying”, “displaying”, “requesting”, “monitoring”, “changing”, “updating”, “establishing”, “initiating”, or the like, refer to actions and processes of a computer system or similar electronic computing device or processor. The computer system or similar electronic computing device manipulates and transforms data represented as physical (electronic) quantities within the computer system memories, registers or other such information storage, transmission or display devices.

A “computer” is one or more physical computers, virtual computers, and/or computing devices. As an example, a computer can be one or more server computers, cloud-based computers, cloud-based cluster of computers, virtual machine instances or virtual machine computing elements such as virtual processors, storage and memory, data centers, storage devices, desktop computers, laptop computers, mobile devices, Internet of Things (IoT) devices such as home appliances, physical devices, vehicles, and industrial equipment, computer network devices such as gateways, modems, routers, access points, switches, hubs, firewalls, and/or any other special-purpose computing devices. Any reference to “a computer” herein means one or more computers, unless expressly stated otherwise.

The “instructions” are executable instructions and comprise one or more executable files or programs that have been compiled or otherwise built based upon source code prepared in JAVA, C++, OBJECTIVE-C, or any other suitable programming environment.

Communication media can embody computer-executable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared and other wireless media. Combinations of any of the above can also be included within the scope of computer-readable storage media.

Computer storage media can include volatile and nonvolatile, removable, and non-removable media implemented in any method or technology for storage of information such as computer-readable instructions, data structures, program modules, or other data. Computer storage media can include, but is not limited to, random access memory (RAM), read only memory (ROM), electrically erasable programmable ROM (EEPROM), flash memory, or other memory technology, compact disk ROM (CD-ROM), digital versatile disks (DVDs) or other optical storage, solid state drives, hard drives, hybrid drive, or any other medium that can be used to store the desired information and that can be accessed to retrieve that information.

It is appreciated that present systems and methods can be implemented in a variety of architectures and configurations. For example, present systems and methods can be implemented as part of a distributed computing environment, a cloud computing environment, a client server environment, hard drive, etc. Example embodiments described herein may be discussed in the general context of computer-executable instructions residing on some form of computer-readable storage medium, such as program modules, executed by one or more computers, computing devices, or other devices. By way of example, and not limitation, computer-readable storage media may comprise computer storage media and communication media. Generally, program modules include routines, programs, objects, components, data structures, etc., that perform particular tasks or implement particular data types. The functionality of the program modules may be combined or distributed as desired in various embodiments.

It should be understood that terms “user” and “participant” have equal meaning in the following description.

Embodiments are described in sections according to the following outline:
1.0 GENERAL OVERVIEW
2.0 STRUCTURAL OVERVIEW
3.0 FUNCTIONAL OVERVIEW
4.0 PROCEDURAL OVERVIEW

### 1.0 General Overview

The current disclosure provides technical solutions to the technological problem of format restrictions that are inherent in digital conferencing platforms. Generally, a conferencing system allows users to share their video feed, audio feed, and text messages with each other during the conference. In some cases, where organizers are engaging a large audience, it is desirable to restrict users from talking or making other contributions to prevent excessive noise and disruptions. However, meetings may also have a set of presenters, hosts, moderators, and/or some participants who need to synchronize with one another before the meeting to discuss issues like the order of presenters or other administrative matters. Silencing all participants, including the presenters, just to prevent noise, would restrict the presenters' ability to collaborate ahead of the meeting. Asking the presenters to join early using the same meeting link as the attendees in order to coordinate may create problems where attendees also join early, catch the presenters preparing, and inadvertently overhear sensitive information.

The current solution solves these problems by providing an efficient technical solution for collaboration before a scheduled meeting. In one aspect of the present disclosure, a computer-implemented method for collaborating before a scheduled meeting is proposed. The method comprises the steps of receiving a request for a participant to join a scheduled meeting; detecting one or more criteria for the participant of the scheduled meeting; based on the one or more criteria, moving the participant to a waiting room; and moving the participant from the waiting room to the scheduled meeting. Therefore, the current solution provides the technological benefit of providing an automated organizational construct within the collaboration environment prior to and separate from a scheduled meeting.

In one embodiment of the present disclosure, prior to moving the participant to the waiting room, the waiting room is generated.

In another embodiment of the present disclosure, the separate waiting room allows the participant to communicate with other participants in the separate waiting room.

In another embodiment, moving the participant from the waiting room to the scheduled meeting comprises, detecting one or more updated values for the one or more criteria of the participant; and based on the one or more updated values for the one or more criteria, moving the participant from the waiting room to the scheduled meeting.

In another embodiment, moving the participant from the waiting room to the scheduled meeting comprises, calculating a waiting room wait time for a plurality of participants based on a predetermined criteria associated with the waiting room; and upon determining that the waiting room wait time has elapsed for the participant, moving the participant from the waiting room to the scheduled meeting.

In another embodiment, the one or more criteria is based on participant information.

In another embodiment of the present disclosure, determining the criteria comprises determining the criteria from an invitation for the scheduled meeting.

In another embodiment, the present disclosure further comprises determining that the participant is joining after a predetermined time and before the scheduled time. The predetermined time is determined by an organizer of the scheduled meeting.

In another embodiment of the present disclosure, the predetermined time is determined from an invitation for the scheduled meeting.

In another embodiment of the present disclosure, the method further comprises causing to display the notification that the participant satisfies the criteria.

In another embodiment of the present disclosure, the method further comprises moving the participant to the separate waiting room in response to user input.

In another embodiment of the present disclosure, the method further comprises, receiving another request for a second participant to join the scheduled meeting; detecting one or more second participant criteria for the second participant; and based on the one or more second participant criteria, moving the second participant to a second waiting room, wherein the second waiting room is separate and distinct from the waiting room.

According to a second aspect of the present disclosure, a system for collaborating before a scheduled meeting is proposed. The system comprises a processor; and a memory storing instructions that, when executed by the processor, causes: receiving a request for a participant to join a scheduled meeting; detecting one or more criteria for the participant of the scheduled meeting; based on the one or more criteria, moving the participant to a waiting room; and moving the participant from the waiting room to the scheduled meeting. Therefore, the current solution provides the technological benefit of providing an automated organizational construct within the collaboration environment prior to and separate from a scheduled meeting.

According to a third aspect of the present disclosure, a non-transitory, computer-readable medium for collaboration before a scheduled meeting is proposed. The medium stores a set of instructions that, when executed by a processor, cause the following: receiving a request for a participant to join a scheduled meeting; detecting one or more criteria for the participant of the scheduled meeting; based on the one or more criteria, moving the participant to a waiting room; and moving the participant from the waiting room to the scheduled meeting. Therefore, the current solution provides the technological benefit of providing an automated organizational construct within the collaboration environment prior to and separate from a scheduled meeting.

### 2.0 Structural Overview

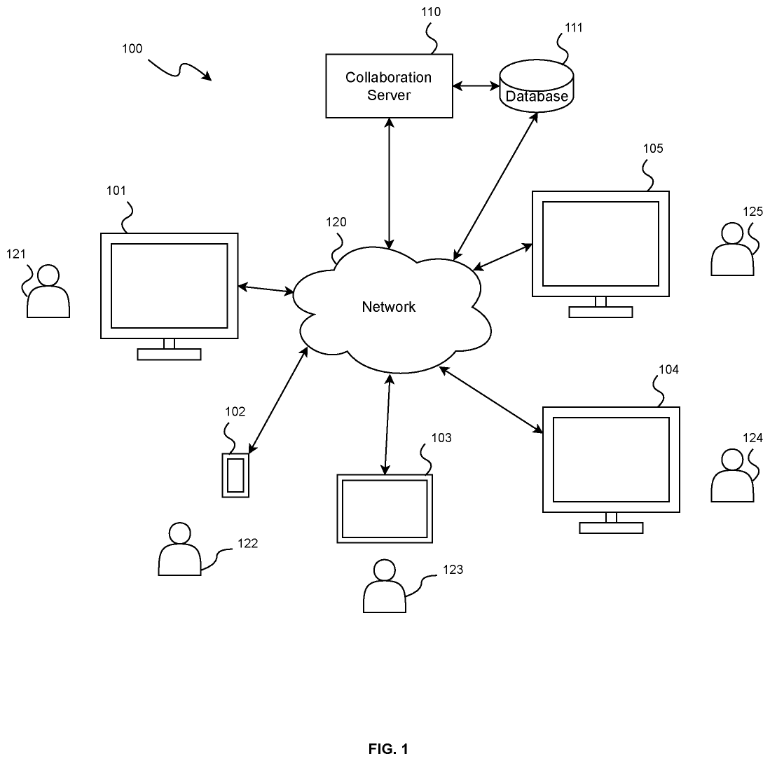

FIG. 1 shows a diagram of a communication system suitable for realization of one of the embodiments of a conferencing platform of the current disclosure.

The communication system 100 facilitates communications between user devices 101, 102, 103, 104, and 105, each associated with corresponding user 121, 122, 123, 124 and 125, a collaboration server 110, and a database 111. Network 120 may be any type of network that provides communications or facilitates the exchange of information between the collaboration server 110 and user devices 101, 102, 103, 104, and 105. For example, network 120 broadly represents one or more local area networks (LANs), wide area networks (WANs), metropolitan area networks (MANs), global interconnected internetworks, such as the public internet, or other suitable connection(s) or combination thereof that enables communication system 100 to send and receive information between the user devices 101, 102, 103, 104, and 105 and the collaboration server 110. Each such network 120 uses or executes stored programs that implement internetworking protocols according to standards such as the Open Systems Interconnect (OSI) multi-layer networking model, including but not limited to Transmission Control Protocol (TCP) or User Datagram Protocol (UDP), Internet Protocol (IP), Hypertext Transfer Protocol (HTTP), and so forth. All computers described herein are configured to connect to the network 120 and the disclosure presumes that all elements of FIG. 1 are communicatively coupled via network 120. A network may support a variety of electronic messaging formats and may further support a variety of services and applications for user devices 101, 102, 103, 104, and 105.

User devices may include, but are not limited to, a desktop user device 101, 104 and 105 executing any known operational environment, e.g., Windows®, MacOS®, Linux® or Unix®. At the same time, other user devices may be mobile telephones, such as smartphone devices, e.g., user device 102, or tablets, e.g., user device 103, executing any of the known operational environments, e.g., Android® or iOS.

In accordance with the present disclosure, user devices 101, 102, 103, 104 and 105 may exchange invitations for a scheduled meeting with each other via network 120. In an embodiment, collaboration server 110 may also facilitate exchanging the invitations for a scheduled meeting between users 122, 122, 123, 124 and 125.

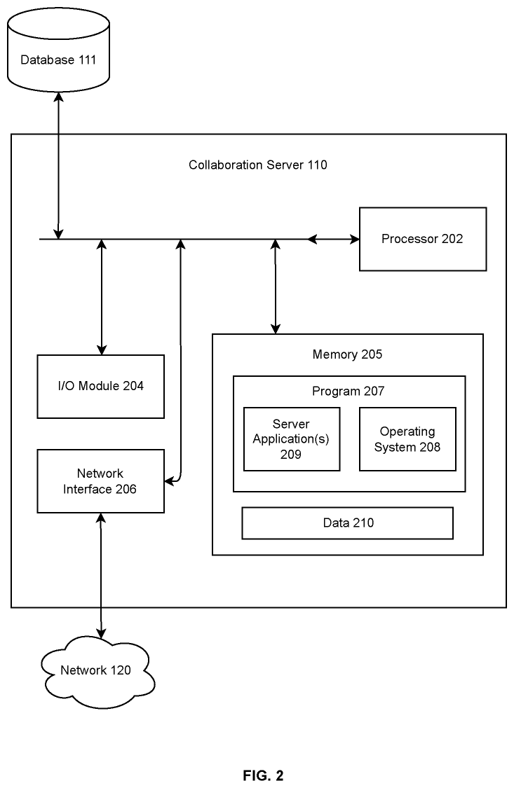

FIG. 2 is a diagram of a server, according to an example embodiment. Specifically, FIG. 2 represents a block diagram that illustrates an example of a server suitable for implementing the disclosed systems and methods. Collaboration server 110 represents the server. The collaboration server 110 may include at least one processor, e.g., processor 202. The processor 202 may be operably connected to one or more databases (e.g., database 111), an input/output (I/O) module 204, memory 205, and network interface device 206.

I/O module 204 may be operably connected to a keyboard, mouse, touch screen controller, and/or other input controller(s) (not shown). Other input/control devices connected to I/O module 204 may include one or more touchpads, trackballs, buttons, rocker switches, thumbwheel, infrared port, USB port, and/or a pointer device such as a stylus.

Processor 202 may also be operably connected to memory 205. Memory 205 may include high-speed random-access memory and/or non-volatile memory, such as one or more magnetic disk storage devices, one or more optical storage devices, and/or flash memory (e.g., using NAND, NOR gates).

Memory 205 may include one or more programs 207. For example, memory 205 may store an operating system 208, such as DARWIN, RTXC, Linux®, iOS, Unix®, OS X, Windows®, or an embedded operating system such as VXWorks®. Operating system 208 may include instructions for handling basic system services and for performing hardware dependent tasks. In some implementations, operating system 208 may comprise a kernel (e.g., UNIX kernel).

Memory 205 may also store one or more server applications 209 to facilitate communicating with one or more additional devices, one or more computers and/or one or more servers. Server applications 209 may also include instructions to execute one or more of the disclosed methods.

Memory 205 may also store data 210. Data 210 may include transitory data used during instruction execution. Data 210 may also include data recorded for long-term storage.

Each of the above identified instructions and applications may correspond to a set of instructions for performing one or more functions described above. These instructions need not be implemented as separate software programs, procedures, or modules. Memory 205 may include additional instructions or fewer instructions. Furthermore, various functions of collaboration server 110 may be implemented in hardware and/or in software, including in one or more signal processing and/or application specific integrated circuits.

Communication functions may be facilitated through one or more network interfaces (e.g., network interface 206). Network interface 206 may be configured for communications over Ethernet, radio frequency, and/or optical (e.g., infrared) frequencies. The specific design and implementation of network interface 206 depends on the communication network(s) over which collaboration server 110 is intended to operate. For example, in some embodiments, collaboration server 110 includes wireless/wired network interface 206 designed to operate over a GSM network, a GPRS network, an EDGE network, a Wi-Fi® or WiMax® network, and a Bluetooth® network. In other embodiments, collaboration server 110 includes wireless/wired network interface 206 designed to operate over a TCP/IP network. Accordingly, network 120 may be any appropriate computer network compatible with network interface 206.

The various components in collaboration server 110 may be coupled by one or more communication buses or signal lines (not shown).

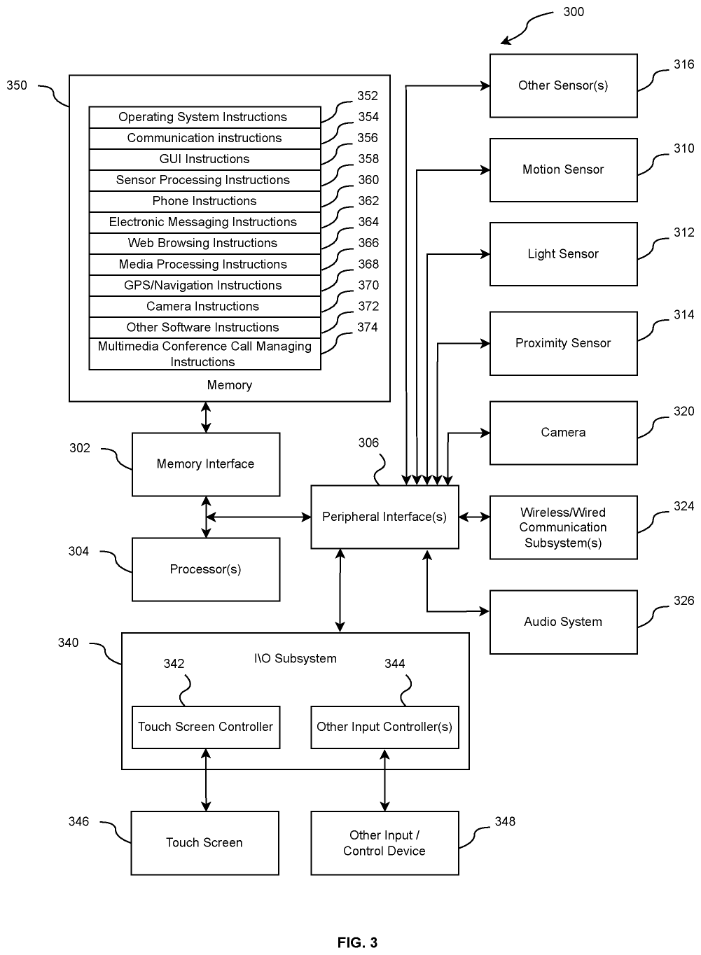

FIG. 3 is a diagram of a user device 300 for use in a communication system, such as communication system 100. The user device 300 can be used to implement computer programs, applications, methods, processes, or other software to perform embodiments described in the present disclosure, such as the user devices 102, 104, 106, and 108. The user device 300 includes a memory interface 302, a peripheral interface 306, one or more processors 304 such as data processors, image processors and/or central processing units. a peripheral interface 306. The memory interface 302, the one or more processors 304, and/or the peripheral interface 306 can be separate components or can be integrated in one or more integrated circuits. The various components in the user device 300 can be coupled by one or more communication buses or signal lines.

Sensors, devices, and subsystems can be coupled to the peripherals interface 306 to facilitate multiple functionalities. For example, a motion sensor 310, a light sensor 312, and a proximity sensor 314 can be coupled to the peripherals interface 206 to facilitate orientation, lighting, and proximity functions. Other sensors 316 can also be connected to the peripherals interface 306, such as a positioning system (e.g., GPS receiver), a temperature sensor, a biometric sensor, or other sensing device, to facilitate related functionalities. A GPS receiver can be integrated with, or connected to, the user device 300. For example, a GPS receiver can be built into mobile telephones, such as smartphone devices, e.g., user device 104, or into laptop, e.g., user device 106. GPS software allows mobile telephones to use an internal or external GPS receiver (e.g., connecting via a serial port or Bluetooth®). A camera 320 and an optical sensor 322, e.g., a charged coupled device (“CCD”) or a complementary metal-oxide semiconductor (“CMOS”) optical sensor, may be utilized to facilitate camera functions, such as recording photographs and video clips.

Communication functions may be facilitated through one or more wireless/wired communication subsystems 324, which includes an Ethernet port, radio frequency receivers and transmitters and/or optical (e.g., infrared) receivers and transmitters. The specific design and implementation of the wireless/wired communication subsystem 324 depends on the communication network(s) over which the user device 300 is intended to operate. For example, in some embodiments, the user device 300 includes wireless/wired communication subsystems 324 designed to operate over a GSM network, a GPRS network, an EDGE network, a Wi-Fi® or WiMax® network, and a Bluetooth® network.

An audio system 326 may be used to facilitate voice-enabled functions, such as voice recognition, voice replication, digital recording, and telephony functions.

The I/O subsystem 340 includes a touch screen controller 342 and/or other input controller(s) 344. The touch screen controller 342 is coupled to a touch screen 346. The touch screen 346 and touch screen controller 342 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 346. While a touch screen 346 is shown in FIG. 3, the I/O subsystem 340 may include a display screen (e.g., CRT or LCD) in place of the touch screen 346.

The other input controller(s) 344 is coupled to other input/control devices 348, such as one or more buttons, rocker switches, thumbwheel, infrared port, USB port, and/or a pointer device such as a stylus. The touch screen 346 can, for example, also be used to implement virtual or soft buttons and/or a keyboard.

The memory interface 302 is coupled to memory 350. The memory 350 includes high-speed random-access memory and/or non-volatile memory, such as one or more magnetic disk storage devices, one or more optical storage devices, and/or flash memory (e.g., NAND, NOR). The memory 350 stores an operating system 352, such as DARWIN, RTXC, Linux®, iOS, Unix®, OS X, Windows®, or an embedded operating system such as VXWorks®. The operating system 352 can include instructions for handling basic system services and for performing hardware dependent tasks. In some implementations, the operating system 352 can be a kernel (e.g., UNIX kernel).

The memory 350 may also store communication instructions 354 to facilitate communicating with one or more additional devices, one or more computers and/or one or more servers. The memory 350 can include graphical user interface instructions to facilitate graphic user interface processing; sensor processing instructions to facilitate sensor-related processing and functions; phone instructions to facilitate phone-related processes and functions; electronic messaging instructions to facilitate electronic-messaging related processes and functions; web browsing instructions to facilitate web browsing-related processes and functions; media processing instructions to facilitate media processing-related processes and functions; GPS/navigation instructions to facilitate GPS and navigation-related processes and instructions; camera instructions to facilitate camera-related processes and functions; and/or other software instructions to facilitate other processes and functions. The memory 350 may also include multimedia conference call managing instructions to facilitate conference call related processes and instructions.

In some embodiments, the communication instructions 354 represent or include software applications to facilitate connection with the collaboration server 112 of FIG. 1 that connects a plurality of user devices. The electronic messaging instructions 362 may include a software program to generate communication requests to the collaboration server 112 for carrying out communications. Further, the electronic messaging instructions 362 may include software applications to receive communication requests from the collaboration server 112. The graphical user interface instructions 356 may include a software program that facilitates display of the communication notifications to a user associated with the user device and facilitates the user to provide user input, and so on.

In the presently described embodiment, the instructions cause the processor 304 to perform one or more functions of the disclosed methods. For example, the instructions may cause the displaying of notifications, the sending of information to the collaboration server 110 or the receiving of information from the collaboration server 110.

Each of the above identified instructions and software applications may correspond to a set of instructions for performing one or more functions described above. These instructions may be implemented as separate software programs, procedures, or modules. The memory 350 may include additional instructions or fewer instructions. Furthermore, various functions of the user device 300 may be implemented in hardware and/or in software, including in one or more signal processing and/or application specific integrated circuits.

The user device 300 of FIG. 3 or the user devices 101, 102, 103, 104, and 105 of FIG. 1 may execute various applications stored in memory 350. For the sake of the present disclosure, the memory 350 of the user device 300 may store a conferencing application of a conferencing platform which, when executed by the processor 202, instructs the user device to communicate with the collaboration server 110 or other user devices 101, 102, 103, 104, and 105 via the network 120 of FIG. 1. In an embodiment, the conferencing application may be a browser-based application being part of the conferencing platform. In another embodiment, the conferencing application may be an application that uses Web Real-Time Communication (WebRTC).

Additionally, the memory 350 of the user device may store an application facilitating the exchange of invitations for a scheduled meeting between users on an example of the communication system 100 of FIG. 1. In a particular implementation, memory 350 may store a mailing application, e.g., Microsoft® Outlook® or similar application enabling users to send emails/messages containing information about the scheduled meeting.

### 3.0 Functional Overview

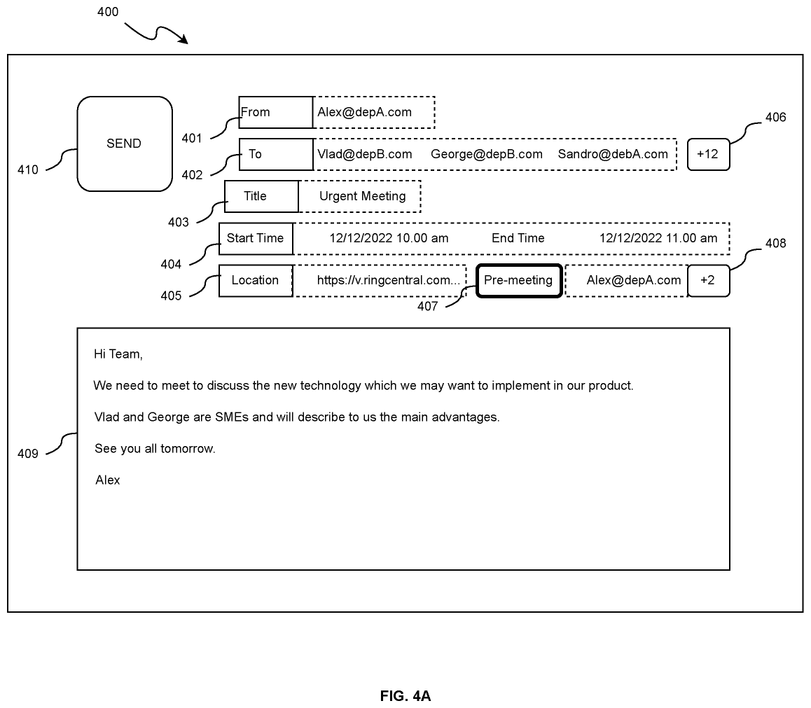

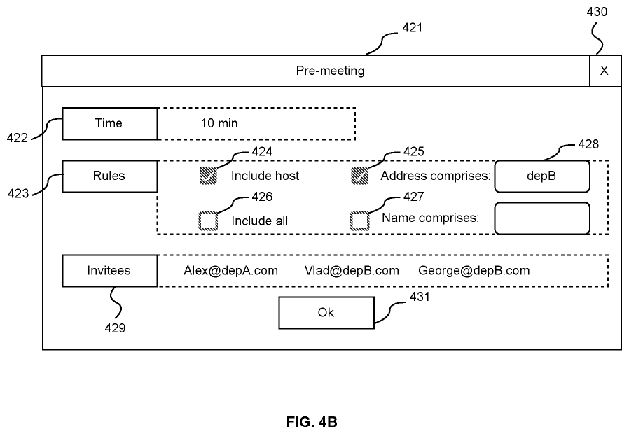

FIGS. 4A-4B depict multiple examples of a GUI implemented for creating a meeting invitation, according to embodiments. The meeting invitation may be created using user device 300 of FIG. 3. Referring to FIG. 4A, GUI 400 depicts an example GUI for creating a meeting invitation and configuring whether the meeting will be enabled with a pre-meeting conference. Fields 401-405 represent fields for creating a new meeting invitation. Field 401 represents a “From” field that indicates which user created the meeting invitation. For example, field 401 contains the email address of Alex (email: Alex@depA.com), who is the person who created the meeting invitation. Field 402 contains email addresses of recipients of the meeting invitation. For instance, field 402 contains email addresses for Vlad (email: vlad@depA.com), George (email: george@depA.com), and Sandro (email: sandro@depA.com). In some cases, field 402 may display only a subset of email addresses for invited meeting participants. This may occur when the number of invited meeting participants is too large to fit into field 402. Control button 406 is a button implemented to show the hidden invitees. In the current example, control button 406 may be implemented to show the number of invited meeting participants that are not shown in field 402. Control button 406, upon being pressed, may show the remaining invited meeting participants. In an embodiment, pressing control button 406 may cause GUI 400 to generate a new popup window to display the hidden invited meeting participants.

In an embodiment, field 403 represents a meeting title field for setting the name of the meeting. For instance, in FIG. 4A, the meeting title in field 403 is named “Urgent Meeting”. Field 404 represents a field for setting and displaying the start and end times for the meeting. For example, in FIG. 4A, the meeting has a start time of “Dec. 12, 2022 at 10:00 AM” and an end time of “Dec. 12, 2022 at 11:00 AM”. In other embodiments, the date/time format for displaying the meeting start and end times may vary. For instance, date/time format examples may include, but are not limited to, Dec. 12, 2022 10:00, Mon Dec. 12, 2022, 10:00 AM, Monday, Dec. 12, 2022, 10 AM, or any other date/time format. In an embodiment, field 405 depicts the location for the meeting. In the current example, field 405 displays a virtual meeting link (https://v.ringcentral.com . . . ). In other examples, the location may represent a virtual meeting link, a physical conference room, or any other physical or virtual space.

In an embodiment, text field 409 represents a text field where the creator of the meeting invitation may include descriptive text describing the purpose of the meeting invitation and any other information. In the current example, text field 409 contains a written message from Alex to the team indicating the purpose of the meeting and who will be presenting at the meeting. In an embodiment, control button 410 is a “SEND” control button implemented to generate and send the meeting invitation to the recipients listed in field 402.

In an embodiment, GUI 400 includes a “Pre-meeting” control button 407 and control button 408. Upon selecting the control button 407, a pre-meeting popup window may be displayed for configuring details for the pre-meeting, including, but not limited to, selecting invitees, setting pre-meeting start/end time, pre-meeting rules, and any other configuration options. Control button 408 is implemented such that, upon selecting control button 408, the field expands to a list of all invitees invited to the collaboration pre-meeting before the scheduled meeting. Control button 408 may display the number of invitees invited to the pre-meeting. For example, control button 408 displays a “+2” which means that 2 people have been invited to the pre-meeting collaboration. In an example, upon selecting the control button 407, an additional window, within the GUI, may be generated to display the invitees invited to the pre-meeting.

FIG. 4B depicts an example of a pre-meeting popup window 421 for configuring collaboration details for the pre-meeting. Pre-meeting popup window 421 may be displayed as a popup window over the GUI 400 of FIG. 4A. While the example of FIG. 4B illustrates an additional window, this embodiment is not intended to be limiting. In another embodiment, pre-meeting options may be included within GUI 400 of FIG. 4A without a window expansion, for example.

In an embodiment, pre-meeting popup window 421 includes a “Time” field 422, where the user may indicate a scheduled time for the pre-meeting. Field 422 displays the pre-meeting time in terms of a duration of time before the scheduled meeting time. For example, in FIG. 4B, the user elected to schedule a pre-meeting to begin 10 minutes prior to the scheduled meeting. If the meeting is scheduled for 10 AM, then the pre-meeting would begin 10 minutes prior to the scheduled 10 AM, which would be 9:50 AM. It should be appreciated that any amount of time may be inputted into field 422. In an embodiment, the pre-meeting popup window 421 may allow the user to select a time for the pre-meeting that ends one or more minutes before the time of the scheduled meeting. For example, if the pre-meeting is scheduled to start 10 minutes prior to the scheduled 10 AM meeting and is scheduled to end one minute before the scheduled meeting, then the pre-meeting would be scheduled to start at 9:50 AM and end at 9:59 AM.

In an embodiment, pre-meeting popup window 421 includes a “Rules” field 423, where the user may customize criteria or rules for the pre-meeting. Rules for the pre-meeting may include, but are not limited to, whether to automatically include the host, whether to include all invitees of the scheduled meeting to the pre-meeting, a search/filter feature for identifying invitees based on their email addresses, and a search/filter feature for identifying invitees based on their names. Referring to the FIG. 4B, the rules criteria in field 423 may include the following options: an “Include Host” checkbox 424, an “Address comprises” checkbox 425, an “Include All” checkbox 426, and a “Name comprises” checkbox 427. The “Include Host” checkbox 424, when selected, invites the host to the pre-meeting. The “Include All” checkbox 426, when selected, invites all invitees for the scheduled meeting to the pre-meeting. The “Address comprises” checkbox 425, when selected, allows the user to enter a regular expression for matching invitee email addresses. The system identifies invitees for the pre-meeting based on whether invitee email addresses match the inputted regular expression. Using the example depicted in FIG. 4B, field 428 contains the expression “depB”, which indicates that the collaboration server 110 should identify, and invite to the pre-meeting, invitees whose email address contains the text “depB”. The “Name comprises” checkbox 427, when selected, allows the user to enter a regular expression for matching invitee names. The system uses the inputted “Name comprises” regular expression to identify invitees based on whether invitee names match the inputted regular expression.

The “Invitees” field 429 is implemented to display the email addresses of the invitees who are invited to the pre-meeting. For example, referring to FIG. 4B, field 429 contains the email addresses of Alex@depA.com, vlad@depB.com, and george@depB.com. The email address alex@depA.com is included because the “Include host” checkbox 411 is selected and Alex is the meeting host. The email addresses vlad@depB.com and george@depB.com are included based on the “Address comprises” checkbox 413 being selected and field 428 containing “depB”, which matches the email addresses for Vlad and George. In an embodiment, the application may be an email application, conferencing application or other application connected to a corporate address book, like a corporate messenger application (e.g., Slack®, Signal® or Discord®). Additionally, the pre-meeting popup window 421 includes an “X” control 430 to close the pre-meeting popup window 421 and an “OK” control 431 to save the data and go back to the GUI 400 of FIG. 4A.

It should be appreciated that criteria are not limited to the participant's name or email address. The criteria may use any information associated with the participant to identify the user, such as a participant's unique identifier, username, phone number, or other information distinguishing the participant from other participants. In a particular example, a participant may use a pseudonym, alias, or nickname. In another example, a participant may use an anonym to protect their identity from other participants in the pre-meeting conference or within the scheduled meeting. In this example, a conferencing mechanism may be provided to a participant seeking to protect their identity such that only select individuals, such as the organizer or host, know this anonym. In some embodiments, the criteria may be based on characteristics of a participant, such as a department, organization, geolocation, location in a network (IP address), or title. In yet another embodiment, the criteria may be based on the metadata that is shared with the server 110 upon connecting to the server 110 without explicit instructions from a participant.

In an embodiment, a participant's information may be hidden from other participants upon the participants' connection to the pre-meeting conference or the scheduled meeting. This information may be associated with participants and stored in the memory of the collaboration server 110 or in the database 111. In a particular example, the criteria may be the job title of a participant, but the user device 101, upon connecting to the collaboration server 110, does not share this data with the collaboration server 110. In some embodiments, the collaboration server 110 may access this information in an external database, like a Microsoft Exchange Server®.

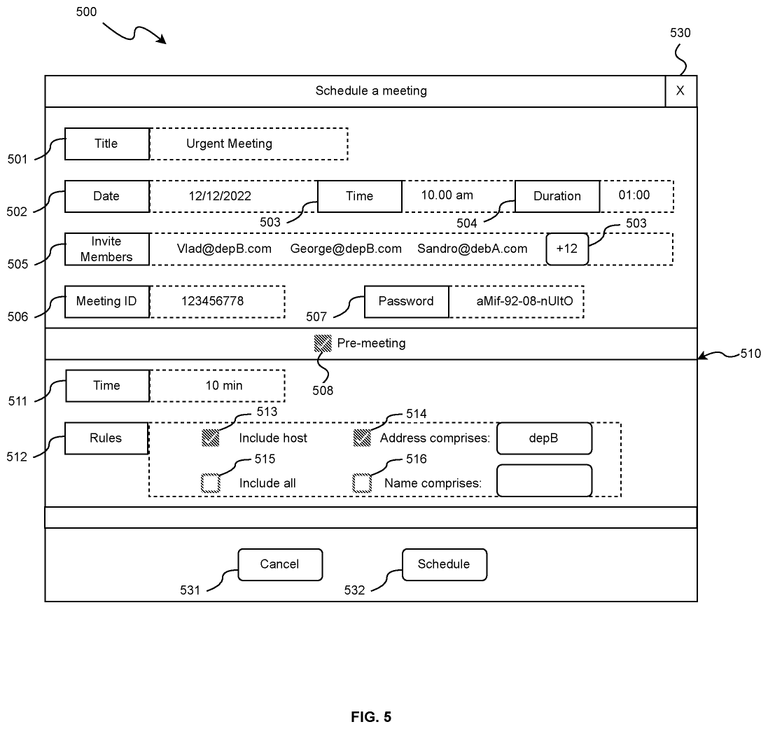

FIG. 5 depicts another example of a GUI implemented for creating a meeting invitation, according to embodiments. The GUI example depicted in FIG. 5 may be part of a conferencing application stored on a user device, e.g., one of the user devices 101, 102, 103, 104, and 105 of FIG. 1 or the user device 300 of FIG. 3. GUI 500 includes the “Title” field 501, the “Date” field 502, the “Time” field 503, the “Duration” field 504, the “Invite members” field 505, the “Meeting ID” field 506, and the “Password” field 507 as regular fields, as in the previous example of GUI 400 of FIG. 4A, for scheduling a meeting.

The GUI 500 further includes a “Pre-meeting” menu 510 for configuring pre-meeting options. The menu 510 represents another embodiment of the pre-meeting popup window 421, where the menu 510 is embedded within GUI 500, as opposed to being displayed as a separate popup window. Menu 510 may be displayed by selecting “Pre-meeting” checkbox 508. Menu 510 includes a “Time” field 511, where the user may indicate a duration of time before the scheduled time when invitees can join the pre-meeting session. In the example depicted in FIG. 5, user Alex selected the 10-minute period immediately prior to the scheduled meeting. Menu 510 also features a “Rules” field 512. Field 512 contains customizable criteria or rules for the pre-meeting. In this example, the criteria include options to select: the “Include Host” checkbox 513, the “Address comprises” checkbox 514, the “Include All” checkbox 515 and the “Name comprises” checkbox 516. Additionally, GUI 500 includes the “X” control 530 and the “Cancel” control 531 to close GUI 500, and the “Schedule” control 532 to send out the invitation.

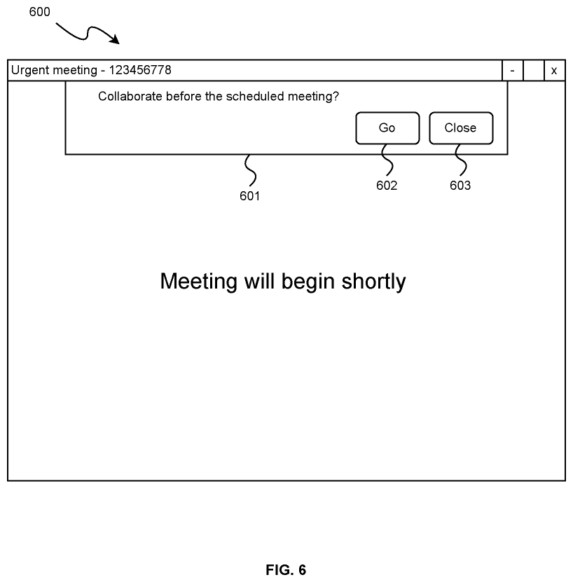

In an embodiment, meeting invitees that were also invited to the pre-meeting may receive a notification to join the pre-meeting prior to the start of the scheduled meeting. FIG. 6 illustrates an example embodiment of a GUI for the conferencing application, prior to the start of the scheduled meeting. GUI 600 represents the state of the conferencing application prior to the start of the scheduled meeting. GUI 600 may represent part of the conferencing application stored in a memory of a user device, e.g., user device 200 of FIG. 2. In another embodiment, the user device may run a browser application through which the user accesses a conferencing system, e.g., the communication system 100 of FIG. 1. The main window of GUI 600 may display “Meeting will begin shortly” to indicate that the scheduled meeting has not yet started.

In an embodiment, notification 601 may be displayed within GUI 600. Notification 601 is a notification indicating that the user may be moved to a separate meeting room designated for the pre-meeting or pre-meeting collaboration. In the current example, notification 601 contains the message “Go to collaborating before the scheduled meeting?” informing the user that they may go to the pre-meeting collaboration. Notification 601 may include a “Go” control button 602 for moving the user to a separate meeting room to collaborate before the scheduled meeting. Notification 601 may also include a “Close” control button 603 to decline the pre-meeting collaboration and to remain in the main waiting room. In another embodiment, the user may be automatically moved to the separate meeting room without the notification 601 and/or controls.

In yet another embodiment, upon connecting to the meeting and satisfying the criteria, a user may be provided with an additional window or menu for setting up the pre-meeting within a GUI of the conferencing system. The additional window or menu may be similar to the menu for setting a collaboration before the scheduled meeting, e.g. GUI 500 of FIG. 5. The window may be used by the user to add additional participants, change time, or create a separate meeting room. Referring to one such example, within the GUI 600, the communicating system may prompt the user with an additional window (e.g., the additional window 421 of FIG. 4B) for setting up a separate meeting room for adding other participants to a pre-meeting room or changing the rules for a pre-meeting room. Alternatively, the communication system may render a menu (e.g., the “Pre-meeting” menu 510 of FIG. 5) within the GUI 600.

In some embodiments, the collaboration before the scheduled meeting may include more than one separate meeting room. For example, for a meeting where two or more different sets of stakeholders will be participating, it would be advantageous to have a separate waiting room for each of the different sets of stakeholders.

### 4.0 Procedural Overview

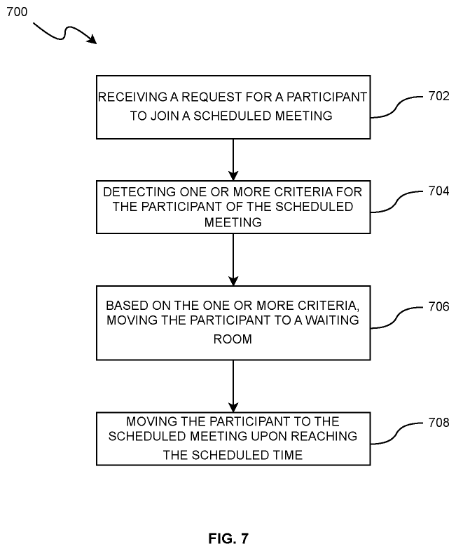

FIG. 7 depicts a flowchart for implementing a waiting room within a conferencing platform before a scheduled meeting. Process 700 may be performed by a single program or multiple programs. The steps of the process as shown in FIG. 7 may be implemented using processor-executable instructions that are stored in computer memory. For the purposes of providing a clear example, the steps of FIG. 7 are described as being performed by computer programs executing on either collaboration server 110 or user device 300. For the purposes of clarity, process 700 is described in terms of a single entity.

At step 702, process 700 receives a request for a participant to join a scheduled meeting. In an embodiment, collaboration server 110 receives a request for a participant to join a scheduled meeting. The request may be generated at the time the participant attempts to join the scheduled meeting. Alternatively, the request may be generated when the participant accepts a meeting request for the scheduled meeting. In another embodiment, an application on a client device may receive and process the request to join the scheduled meeting. For instance, user device 300, which represents the participant's client device, may receive, and process the request for the participant to join a scheduled meeting.

At step 704, process 700 detects one or more criteria for the participant of the scheduled meeting. In an embodiment, server application 209 detects criteria associated with the participant and determines whether the participant is authorized to be moved to a waiting room. The one or more criteria may represent participant-specific information, such as a participant's title and/or role in a department or section or information that indicates the participant's role in the meeting. For instance, the participant may be a presenter for this specific meeting. Server application 209 may be configured to detect and/or extract participant-specific information from various sources, including, but not limited to, the meeting invitation itself, databases and/or data repositories configured to store staff records, or additional information provided by the meeting organizer. For example, databases configured to store staff records may represent database data that describes roles for employees. Additional information provided by the meeting organizer may represent any additional information the meeting organizer provides to the server application 209. For example, the meeting organizer may label a subgroup of participants as presenters.

In an embodiment, server application 209 may analyze the one or more criteria to determine whether a participant should be moved into a specific waiting room. For example, a presenter-specific waiting room may exist where presenters may collaborate prior to joining the scheduled meeting. The criteria associated with the participant may be evaluated to determine whether the participant is a presenter. For example, the meeting invitation may refer to the participant as a presenter. If the server application 209 detects that the participant is a presenter, then the server application 209 may determine that the presenter is eligible to be moved to the presenter-specific waiting room. Alternatively, if the server application 209 detects that the participant is not a presenter for the current meeting, then the server application 209 may determine that the participant is not eligible to be moved to the presenter-specific waiting room. The participant may be eligible for one or more other waiting rooms based on their criteria.

At step 706, process 700 moves the participant to the waiting room based on the one or more criteria. In an embodiment, server application 209, moves the participant to the waiting room, based on the one or more criteria associated with the participant. For example, if server application 209 determines from the one or more detected criteria that the participant is a presenter, then server application 209 may move the participant to a waiting room designated for participants that are presenters. In an embodiment, server application 209 may determine whether to move the participant to a waiting room by comparing the participant's one or more criteria to criteria associated with potential waiting rooms. For instance, waiting room criteria may be stored in database 111. The server application 209 may then retrieve waiting room criteria from database 111 and compare the participant's one or more criteria to the waiting room criteria to determine whether the participant should be moved to a specific waiting room. For example, if the server application 209 determines that the participant is a presenter, then the server application 209 may move the participant to a “presenter waiting room” where all presenters of the meeting are placed.

In an embodiment, a specific waiting room may be generated prior to moving the participant. Using the previous example, if the server application 209 determines that the participant is a presenter and that the presenter waiting room does not yet exist, then the server application may first generate the “presenter waiting room” and then move the participant to the presenter waiting room. If a second participant joins the meeting, the server application 209 may determine that the second participant is a presenter and may move the second participant to the already created presenter waiting room.

In an embodiment, once a participant has been moved to a specific waiting room, the participant has the capability to communicate with other participants within the waiting room. Using the current example, once the second participant has been moved to the presenter waiting room, the second participant may communicate with the first participant or any other participants in the presenter waiting room. Communications made within a waiting room, such as chat messages, are separate from communications captured in the scheduled meeting and may not be viewed by participants outside of the waiting room.

In an embodiment, a participant may or may not be moved to a waiting room based on when the participant joins the scheduled meeting. For example, if a participant joins the scheduled meeting at a time that is after the start of the scheduled meeting, the server application 209 may move the participant directly into the scheduled meeting, without using a waiting room. As described previously, the server application 209 may take into account the one or more criteria associated with the participant. For instance, if the participant joins the scheduled meeting at a time that is after the start of the scheduled meeting and the participant is a presenter, then the server application 209 may move the participant to a presenter-specific waiting room.

In an embodiment, when a participant joins a scheduled meeting prior to the start of the scheduled meeting, the server application 209 may determine whether to immediately move the participant to a waiting room based on how early the participant joined the meeting. For example, when a participant joins the scheduled meeting before the scheduled time, the server application 209 calculates a time difference between when the participant establishes a connection and the scheduled time of the meeting. The server application 209 may compare the calculated time difference with a predetermined time stored in the memory (e.g. the predetermined time represents a time before the scheduled time indicated in the invitation created using GUI 410 of FIG. 4B). If the calculated time difference is more than the predetermined time indicated in the invitation, the server application 209 keeps the participant in the main waiting room. If the calculated time difference is less than the predetermined time indicated in the invitation, which means that the participant joined the meeting before the scheduled meeting time, but after a time at which the collaboration before the scheduled time may take place, the server application 209 may proceed with moving the participant to a waiting room.

At step 708, process 700 moves the participant to the scheduled meeting upon reaching the scheduled time. In an embodiment, server application 209 determines that it is time for the scheduled meeting to start and moves the participant back to the main waiting room so that the participant may participate in the meeting with all other participants of the scheduled meeting. In the embodiment, the server application 209 may terminate the separate waiting room after moving participants from the waiting room to the scheduled meeting.

In an embodiment, server application 209 may move a participant from the waiting room to the scheduled meeting based on the participant's criteria and/or based upon changes to the participant's criteria. For example, a presenter-specific waiting room may contain presenters who are waiting to present during the scheduled meeting. The server application 209 may be configured to assign each presenter a presentation order number, where the presentation order number represents the order in which presenters are scheduled to present. When a presenter is called to present, the server application 209 may move the scheduled presenter to the scheduled meeting and may update the presentation order numbers for each of the remaining presenters in the presenter-specific waiting room. When the next presenter is scheduled to present, the application server 209 may move the next presenter to the scheduled meeting room and may decrement the presentation order numbers for each of the remaining presenters.

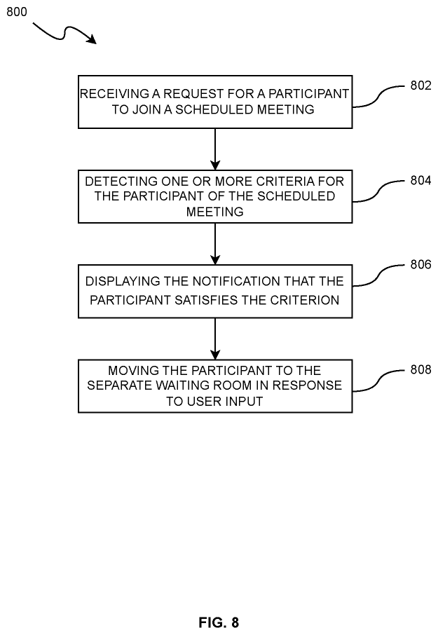

FIG. 8 depicts another flowchart for implementing a waiting room in which a participant may elect to be moved to a specific waiting room. Process 800 may be performed by a single program or multiple programs. The steps of the process as shown in FIG. 8 may be implemented using processor-executable instructions that are stored in computer memory. For the purposes of providing a clear example, the steps of FIG. 8 are described as being performed by computer programs executing on either collaboration server 110 or user device 300. For the purposes of clarity, process 800 is described in terms of a single entity.

At step 802, process 800 receives a request for a participant to join a scheduled meeting. In an embodiment, collaboration server 110 receives a request for a participant to join a scheduled meeting. Details and examples for step 802 may be similar to step 702 in FIG. 7.

At step 804, process 800 detects one or more criteria for the participant of the scheduled meeting. In an embodiment, server application 209 detects criteria associated with the participant and determines whether the participant is authorized to be moved to a waiting room. Details and examples for step 804 may be similar to step 704 in FIG. 7.

At step 806, process 800 displays a notification that the participant satisfies the criteria. In an embodiment, server application 209 may display a notification that the participant satisfies the criteria. For example, the notification may be notification 610 of GUI 600 in FIG. 6. In other examples, server application 209 may display the notification with settings for the collaboration before the scheduled meeting time, where the participant may add other participants or change the time for the collaboration before the scheduled meeting time. Upon receiving the participant's input regarding the collaboration before the scheduled time, server application 209 proceeds to step 808. In another embodiment, server application 209 may send, to the user device, e.g., user device 101 or user device 300, the instructions to display the notification within the GUI of the collaboration application or a browser application running on either user device 101 or user device 300.

At step 808, process 800 moves the participant to the separate waiting room in response to user input. In an embodiment, server application 209 may receive, from the user device, instructions to move the participant to the separate waiting room. Upon receiving the instructions to move the participant, the server application 209 moves the participant into the waiting room.

In another embodiment, if the participant specifies changes to the criteria for a particular waiting room, the server application 209 may generate instructions to amend the criteria for the particular waiting room, which may include, but is not limited to, adding new participants to the waiting room criteria, changing the time for collaborating before the scheduled meeting time, and any other configurable changes to who may join the particular waiting room and when participants may join the particular waiting room. For example, the user may change the time for the collaboration before the scheduled meeting time even before said collaboration takes place. In this example, the server application 209 may display the notification that the participant satisfies the criteria before the predetermined time before the scheduled time indicated in the invitation. In some embodiments, this time may not be specified at all, and the server application 209 causes to display the notification in response to detecting that the participant satisfies the criteria, regardless of the time the participant joins.

In an embodiment, the server application 209 may send to a host or moderator of the meeting a notification that a participant has joined early. The moderator may then have the option to move that participant to the separate meeting room. The participant may also receive a notification (like the notification 601 of FIG. 6) that they have been invited to the separate meeting room. If the invitation is accepted by the participant, e.g. the participant selects the “Go” control 602, then the server application 209 may move the participant to the separate meeting room.

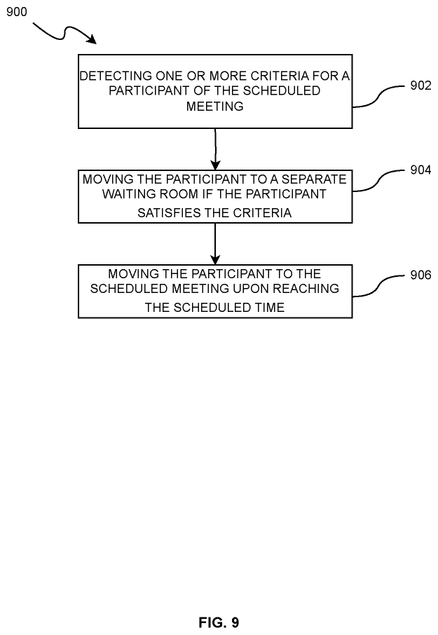

In some embodiments, the application server 209 may determine participant eligibility to join one or more waiting rooms prior to the participant requesting to join the scheduled meeting. FIG. 9 depicts a flowchart for determining whether a participant should be moved to a waiting room prior to the participant joining the scheduled meeting. Process 900 may be performed by a single program or multiple programs. The steps of the process as shown in FIG. 9 may be implemented using processor-executable instructions that are stored in computer memory. For the purposes of providing a clear example, the steps of FIG. 9 are described as being performed by computer programs executing on either collaboration server 110 or user device 300. For the purposes of clarity, process 900 is described in terms of a single entity.

At step 902, process 900 detects one or more criteria for the participant of the scheduled meeting. In an embodiment, server application 209 detects criteria associated with the participant and determines whether the participant is authorized to be moved to a waiting room. In one instance, the server application 209 may detect the one or more criteria for the participant from an invitation for the scheduled meeting. For example, the server application 209 may detect from the content of the invitation that the participant is a specific type of participant such as a presenter or a special guest. Alternatively, the server application 209 may access database 111 to identify the title and/or role of a participant in order to determine whether the participant is authorized to be placed in a specific waiting room.

Upon detecting the one or more criteria, the server application 209 determines whether the participant is eligible to be placed into a specific waiting room. For instance, if the server application 209 detects, from the meeting invitation, that the participant is a presenter, then the server application 209 may determine that the participant is eligible to be placed into a presenter-specific waiting room when the participant joins the scheduled meeting. In an embodiment, server application 209 compares the participant's criteria to criteria associated with one or more potential waiting rooms. If the server application 209 detects that the participant satisfies the criteria for at least one of the waiting rooms, the server application 209 may store, in the memory 205, information describing the eligible waiting rooms for the participant.

Upon the participant joining the meeting, the server application 209 accesses the information stored in the memory 205 corresponding to the participant and determines which waiting room, if any, the participant should be moved into. Referring to FIG. 9, at step 904, process 900 moves the participant to a separate waiting room if the participant satisfies the criteria. For example, when the participant, who is a presenter, joins the meeting, the server application 209 may determine that the participant should be automatically moved to a presenter-specific waiting room. The server application 209 then moves the participant to the presenter-specific waiting room. In an embodiment, if the waiting room that the participant is to be moved into does not exist, then the server application 209 may be configured to first create the waiting room and then move the participant into the newly created waiting room.

At step 906, process 900 moves the participant to the scheduled meeting upon reaching the scheduled time. In an embodiment, the server application 209 identifies that it is time for the scheduled meeting to start and moves the participant back to the main waiting room so that the participant may participate in the meeting with all other participants. In the embodiment, the server application 209 may be further instructed to terminate the separate waiting room. In an embodiment, the server application 209 may send to the user device 300 instructions to display a notification that the scheduled meeting time is approaching soon, so that the participant may be ready for that. For example, the notification may comprise a countdown indicator.

What is claimed is:

1. A computer-implemented method for a conferencing platform before scheduled meetings, comprising:
receiving a request for a participant to join a scheduled meeting;
detecting one or more criteria for the participant of the scheduled meeting;
based on the one or more criteria, moving the participant to a waiting room;
moving the participant from the waiting room to the scheduled meeting.

2. The computer-implemented method of claim 1, further comprising, prior to moving the participant to the waiting room, generating the waiting room.

3. The computer-implemented method of claim 1, wherein participants in the waiting room can communicate with each other outside of the scheduled meeting.

4. The computer-implemented method of claim 1, wherein moving the participant from the waiting room to the scheduled meeting, comprises:
detecting one or more updated values for the one or more criteria of the participant;
based on the one or more updated values for the one or more criteria, moving the participant from the waiting room to the scheduled meeting.

5. The computer-implemented method of claim 1, wherein moving the participant from the waiting room to the scheduled meeting, comprises:
calculating a waiting room wait time for a plurality of participants based on a predetermined criteria associated with the waiting room; and
upon determining that the waiting room wait time has elapsed for the participant, moving the participant from the waiting room to the scheduled meeting.

6. The computer-implemented method of claim 1, wherein the one or more criteria is based on participant information.

7. The computer-implemented method of claim 1, wherein determining the one or more criteria comprises determining the one or more criteria from an invitation for the scheduled meeting.

8. The computer-implemented method of claim 1, further comprising determining that the participant is joining after a predetermined time before the scheduled time, wherein the predetermined time is determined by an organizer of the scheduled meeting.

9. The computer-implemented method of claim 1, further comprising, moving the participant to the separate waiting room in response to user input.

10. The computer-implemented method of claim 1, further comprising:
receiving another request for a second participant to join the scheduled meeting;
detecting one or more second participant criteria for the second participant; and
based on the one or more second participant criteria, moving the second participant to a second waiting room, wherein the second waiting room is separate and distinct from the waiting room.

11. A system for collaboration within a conferencing platform before scheduled meetings, comprising:
a processor; and
a memory storing instructions that, when executed by the processor, causes:
receiving a request for a participant to join a scheduled meeting;
detecting one or more criteria for the participant of the scheduled meeting;
based on the one or more criteria, moving the participant to a waiting room;
moving the participant from the waiting room to the scheduled meeting.

12. The system of claim 11, further comprising, prior to moving the participant to the waiting room, generating the waiting room.

13. The system of claim 11, wherein participants in the waiting room can communicate with each other outside of the scheduled meeting.

14. The system of claim 11, wherein moving the participant from the waiting room to the scheduled meeting, comprises:
detecting one or more updated values for the one or more criteria of the participant;
based on the one or more updated values for the one or more criteria, moving the participant from the waiting room to the scheduled meeting.

15. The system of claim 11, wherein moving the participant from the waiting room to the scheduled meeting, comprises:
calculating a waiting room wait time for a plurality of participants based on a predetermined criteria associated with the waiting room; and
upon determining that the waiting room wait time has elapsed for the participant, moving the participant from the waiting room to the scheduled meeting.

16. The system of claim 11, wherein the one or more criteria is based on participant information.

17. A non-transitory, computer-readable medium, storing a set of instructions that, when executed by the processor, causes:
receiving a request for a participant to join a scheduled meeting;
detecting one or more criteria for the participant of the scheduled meeting;
based on the one or more criteria, moving the participant to a waiting room;
moving the participant from the waiting room to the scheduled meeting.

18. The non-transitory, computer-readable medium of claim 17, further comprising, prior to moving the participant to the waiting room, generating the waiting room.

19. The non-transitory, computer-readable medium of claim 17, wherein participants in the waiting room can communicate with each other outside of the scheduled meeting.

20. The non-transitory, computer-readable medium of claim 17, wherein moving the participant from the waiting room to the scheduled meeting, comprises:
detecting one or more updated values for the one or more criteria of the participant;
based on the one or more updated values for the one or more criteria, moving the participant from the waiting room to the scheduled meeting.
